(19) United States
(12) Patent Application Publication
(10) Pub. No.: US 2007/0139743 A1
(43) Pub. Date: Jun. 21, 2007

(54) IMAGING APPARATUS, IMAGING METHOD, COMPUTER-READABLE PROGRAM, AND COMPUTER-READABLE MEDIUM

(76) Inventor: Yoshiyuki NAMIZUKA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/566,339

(22) Filed: Dec. 4, 2006

(30) Foreign Application Priority Data
Dec. 19, 2005 (JP) 2005-364919

(51) Int. Cl. H04N 1/46

(52) U.S. Cl. 358/537

(57) ABSTRACT

An imaging apparatus is disclosed that includes a storage unit that stores image data, an image data reproducing unit that reproduces the image data, a reproduced image editing unit that performs a first editing process on the reproduced image data and displays an edited image resulting from the first editing process, and an actual image editing unit that performs a second editing process on the image data stored in the storage unit according to the first editing process.

### BACKGROUND OF THE INVENTION

1. Field of the Invention

The present invention relates to an imaging apparatus, an imaging method, a computer-readable program, and a computer-readable medium that are applied to a multi-function printer having printer, scanner, and facsimile (FAX) functions, for example.

2. Description of the Related Art

A multi-function printer (MFP) may have multiple functions including a copying function, a scanner function, a printing function, and/or a facsimile function, for example. In an MFP having a scanner function, an image may be read by a scanner unit to generate image data, and the generated image data may be stored in a storage unit of a controller of the MFP, for example.

The controller may generate a preview image and a thumbnail image corresponding to the image data stored in the storage unit in response to instructions issued via an operations unit.

Also, the controller may perform a process of compiling desired areas of one or more images, photographs, and/or documents stored in the storage unit on one sheet of paper as an index and print out the compiled index (e.g., see Japanese Laid-Open Patent Publication No. 2004-207819).

In an apparatus as is described above, an image display process is also performed by the controller. In the case where such an image display process is performed, the performance of other functional operations of the apparatus such as copying operations may be degraded while the display process is performed. Specifically, the key response speed and display speed of the apparatus may be decreased when multiple functional operations are performed.

It is noted that depiction processes such as stamping, compiling, and hole-punching may also be performed by the controller. In this case, a relatively large amount of data may be transmitted through the data bus between the controller and the operations unit.

Also, in the above-described apparatus, although a preview image corresponding to the image stored in the storage unit may be displayed, a preview image of an edited/processed image resulting from performing a depiction process such as stamping, compiling, and hole-punching on the preview image corresponding to the stored image data may not be displayed.

### SUMMARY OF THE INVENTION

Embodiments of the present invention solve at least one of the above-described problems of the related art. In one aspect of the present invention, an imaging apparatus, an imaging method, a computer-readable program, and a computer-readable medium are provided for enabling display of an edited image that has been edited/processed by a depiction process.

In another aspect of the present invention, an imaging apparatus, an imaging method, a computer-readable program, and a computer-readable medium are provided for reducing degradation in the performance of other functional operations while an image display process is performed.

According to one embodiment of the present invention, an imaging apparatus is provided that includes:

a storage unit that stores image data

an image data reproducing unit that reproduces the image data;

a reproduced image editing unit that performs a first editing process on the reproduced image data and displays an edited image resulting from the first editing process; and

an actual image editing unit that performs a second editing process on the image data stored in the storage unit according to the first editing process.

According to another embodiment of the present invention, an image forming method in provided that includes the steps of:

storing image data;

reproducing the image data;

performing a first editing process on the reproduced image data;

displaying a processed image resulting from the first editing process; and

performing a second image editing process on the image data stored in the storage unit according to the first editing process.

According to other embodiments of the present invention, a computer-readable program implementing the image forming method of the present invention and a computer-readable medium containing such a program are provided.

According to the above-described embodiments of the present invention, an edited/processed image resulting from editing/processing the reproduced image data of image data stored in the storage unit may be displayed, and an image display process may be performed in parallel with another functional process such as a copying process, for example.

### BRIEF DESCRIPTION OF THE DRAWINGS

FIG. 1 is a block diagram illustrating a configuration of an imaging apparatus according to a first embodiment of the present invention;

FIG. 2 is a flowchart illustrating operations of the imaging apparatus according to the first embodiment;

FIG. 3 is a diagram illustrating processes performed by the imaging apparatus according to the first embodiment;

FIG. 4 is a diagram illustrating processes performed by an operations unit of the imaging apparatus according to the first embodiment;

FIG. 5 is a flowchart illustrating a thumbnail image display process performed by the imaging apparatus according to the first embodiment;

FIG. 6 is a flowchart illustrating a preview image display process and editing/processing operations performed by the imaging apparatus according to the first embodiment;

FIG. 7 is a flowchart illustrating processes performed by a controller and the operations unit of the imaging apparatus according to the first embodiment;

FIG. 8 is a diagram illustrating operations performed by the imaging apparatus according to the first embodiment;

FIG. 9 is a diagram illustrating an exemplary display of thumbnail images by the imaging apparatus according to the first embodiment;

FIG. 10 is a flowchart illustrating operations performed by an imaging apparatus according to a second embodiment of the present invention;

FIG. 11 is a diagram illustrating processes performed by the imaging apparatus according to the second embodiment;

FIG. 12 is a diagram illustrating processes performed by an operations unit of the imaging apparatus according to the second embodiment;

FIG. 13 is a flowchart illustrating a thumbnail display process performed by the imaging apparatus according to the second embodiment;

FIG. 14 is a flowchart illustrating a preview image display process performed by the imaging apparatus according to the second embodiment;

FIG. 15 is a flowchart illustrating processes performed by a controller and the operations unit of the imaging apparatus according to the second embodiment;

FIG. 16 is a diagram illustrating operations performed by the imaging apparatus according to the second embodiment; and

FIG. 17 is a diagram illustrating an exemplary display of thumbnail images by the imaging apparatus according to the second embodiment.

### DESCRIPTION OF THE PREFERRED EMBODIMENTS

In the following, preferred embodiments of the present invention are described with reference to the accompanying drawings.

It is noted that in the drawings illustrating the preferred embodiments of the present invention, components having identical functions are given the same numeric references and overlapping descriptions are omitted.

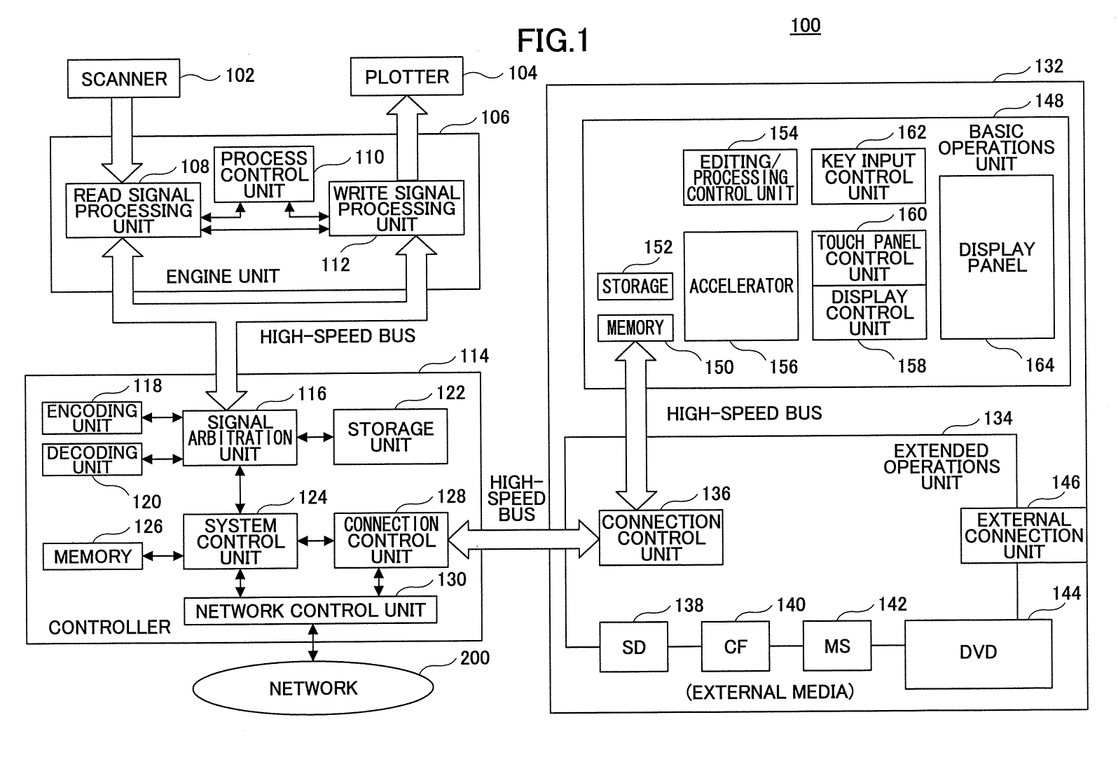

FIG. 1 is a block diagram illustrating a configuration of an imaging apparatus according to a first embodiment of the present invention. It is noted that FIG. 1 shows an imaging apparatus with a scanner function and a plotter function as an illustrative example; however, the present invention is not limited to such an example and may equally be applied to imaging apparatuses having other functions such as a copying function, a printing function, and/or a facsimile function.

The illustrated imaging apparatus 100 according to the present embodiment includes a scanner 102, a plotter 104, an engine unit 106 connected to the scanner 102 and the plotter 104, a controller 114 connected to the engine unit 106 by a high-speed bus, for example, and an operations unit 132 connected to the controller 114 by a high-speed bus.

The engine unit 106 includes a read signal processing unit 108 that inputs an output signal of the scanner 102, a process control unit 110 connected to the read signal processing unit 108, and a write signal processing unit 112. The process control unit 110 is connected to the write signal processing unit 112. The output signal of the write signal processing unit 112 is input to the plotter 104.

The controller 114 includes a signal arbitration unit 116 that inputs/outputs a signal to/from the read signal processing unit 108 and the write signal processing unit 112 via a high-speed bus, an encoding unit 118 connected to the signal arbitration unit 116, a decoding unit 120, a storage unit 122, a system control unit 124 having a reproducing function and an actual image editing function, a memory 126 connected to the system control unit 124, a connection control unit 128, and a network control unit 130. The network control unit 130 is connected to the connection control unit 128 and a network 200.

The operations unit 132 includes an extended operations unit 134 and a basic operations unit 148.

The extended operations unit 134 includes a connection control unit 136 that inputs/outputs a signal to/from the connection control unit 128 via a high-speed bus, for example; an SD card® 138, a compact flash (CF)® 140, a memory stick (MS)® 142, and a DVD 144 as external media; and an external connection unit 146.

The basic operations unit 148 includes a memory 150 that inputs/outputs a signal to/from the connection control unit 136 via a high-speed bus, for example, a storage 152, an editing/processing unit 154, an accelerator 156, a key input control unit 162, a touch panel control unit 160, a display control unit 158, and a display panel 164.

The scanner 102 reads a document image, generates RGB data from the read image, and inputs the RGB data to the read signal processing unit 108. The read signal processing unit 108 processes the input RGB data and inputs the processed RGB data to the signal arbitration unit 116 via the high-speed bus. The signal arbitration unit 116 inputs the processed RGB data to the encoding unit 118. The encoding unit 118 converts the processed RGB data into encoded data and inputs the encoded data to the storage unit 122 via the signal arbitration unit 116. The storage unit 122 stores the encoded data. The system control unit 124 manages storage information of the encoded data stored in the storage unit 122 using file management software that is stored in the memory 126.

The system control unit 124 reproduces and extracts the encoded data stored in the storage unit 122 via the signal arbitration unit 116 and transmits the extracted encoded data to the connection control unit 136 via the connection control unit 128. The connection control unit 136 transmits the input encoded data to the memory 150. It is noted that by converting an image into encoded data, data may be compressed and the amount of transmission data may be reduced compared to a case where image data are transmitted so that high-speed data transmission may be enabled.

The editing/processing control unit 154 decodes the encoded data stored in the memory 150 to generate a thumbnail image. Then, the editing/processing control unit 154 performs a depiction process to display the thumbnail image on the display panel 164. In one embodiment, the editing/processing control unit 154 may use the accelerator 156 to decode the encoded data to generate a thumbnail image.

The editing/processing control unit 154 decodes the encoded data and performs scaling and positioning processes on the decoded data to generate a preview image. Then, the editing/processing control unit 154 performs a depiction process to display the preview image on the display panel 164. In one embodiment, when there are encoded data still remaining in the memory 150, the editing/processing control unit 154 decodes the encoded data stored in the memory 150; on the other hand, when encoded data no longer remain in the memory 150, the editing/processing control unit 154 sends a request to the controller 114 to transmit encoded data and decodes the transmitted encoded data. It is noted that the transmitted encoded data are stored in the memory 150.

The editing/processing control unit 154 performs editing/processing operations on the preview image displayed on the display panel 164. For example, the editing/processing control unit 154 may perform editing/processing operations such as stamping, compiling, and hole-punching on the preview image according to instructions from a user. It is noted that image data corresponding to the preview image being displayed are stored in the memory 150. The editing/processing control unit 154 performs editing/processing operations on the image data stored in the memory 150 and displays the edited/processed preview image on the display panel 164. Also, the editing/processing control unit 154 manages editing history information describing the editing/processing operations performed on the preview image. Then, the editing/processing control unit 154 transmits the editing history information to the system control unit 124 so that the editing/processing operations performed on the preview image may be reflected in the actual image corresponding to the image data stored in the storage unit 122.

The system control unit 124 performs editing/processing operations on the actual image according to the editing history information from the editing/processing control unit 154. Then, the system control unit 124 inputs the edited/processed actual image to the write signal processing unit 112. In turn, the edited/processed actual image may be output by the plotter 104, for example.

In another example, the system control unit 124 may input image data of the edited/processed actual image to the network control unit 130. In this way, the image data of the edited/processed actual image may be output to the network 200 via the network control unit 130.

It is noted that the imaging apparatus according to the present embodiment may comprise an embedded system. Such an embedded system may include a CPU that performs computation processes according to programs, a ROM (read-only memory), a RAM (random access memory), an auxiliary storage device such as a flexible disk device, and a large capacity external storage device such as a hard disk device.

In one embodiment, programs for enabling a computer of the embedded system to function as the controller 114 and the operations unit 132 may be stored in a storage medium such as a flexible disk, a CD-ROM, or a memory card. By inserting the storage medium in the auxiliary storage device of the computer, the programs stored in the storage medium may be read by the CPU. Then, the CPU may write the read programs on the RAM or the external storage device to perform the processes of the above-described imaging apparatus 100 based on the programs. In another embodiment, the programs may be downloaded via the network 200.

It is noted that the program to be executed by the controller 114 may be stored in the memory 112, for example. Such a program may enable the computer to function as a storage unit for storing image data, an image data reproducing unit for reproducing the image data, and an actual image editing unit for performing editing processes on the image data stored in the storage unit according to editing processes performed on the reproduced image data, for example.

In one preferred embodiment, when the computer functions as the actual image editing unit, the program may enable the computer to perform an editing process on the image data stored in the storage unit according to editing history information transmitted from the operations unit 132.

Also, it is noted that the program to be executed by the operations unit 132 may be stored in the storage 152, for example. Such a program may enable the computer to function as a reproduced image editing unit for performing an editing process on the reproduced image data and displaying the edited reproduced image data.

In one preferred embodiment, when the computer functions as the reproduced image editing unit, the programs may enable the computer to generate a thumbnail image from reproduced image data.

In another preferred embodiment, when the computer functions as the reproduced image editing unit, the program may enable the computer to create a preview image corresponding to the thumbnail image and perform an editing process on the preview image.

In another preferred embodiment, when the computer functions as the reproduced image editing unit, the program may enable the computer to transmit editing history information describing the editing process performed on the preview image to the actual image editing unit.

In one embodiment, the controller 114 and the operations unit 132 may each store the programs for enabling execution of their corresponding functions so that the controller 114 and the operations unit 132 may be independently operated and power consumption may be reduced.

In another embodiment, the programs for enabling the functions of the controller 114 and the operations unit 132 may be stored in the controller 114.

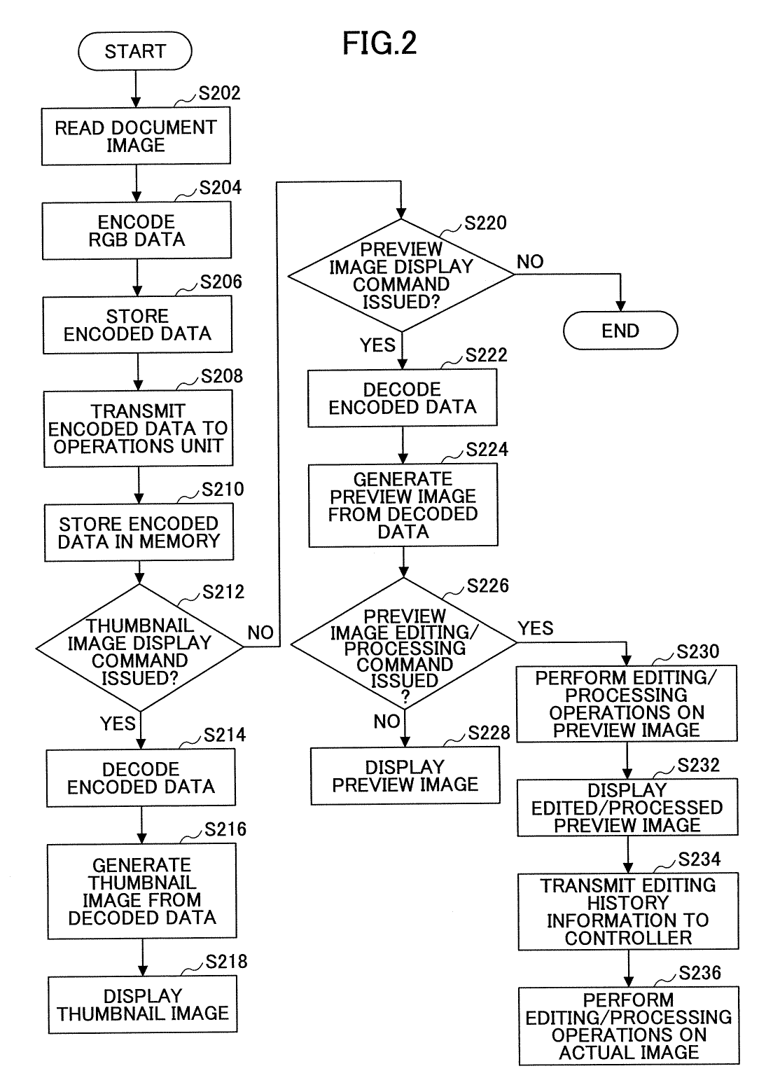

In the following, operations of the imaging apparatus 100 according to the present embodiment are described with reference to FIG. 2.

According to FIG. 2, the scanner 102 reads a document image and generates RGB data (step S202).

Then, signal processing is performed on the RGB data after which the processed RGB data are input to the encoding unit 118. The encoding unit converts the processed RGB data into encoded data (step S204), and stores the encoded data in the storage unit 122 (step S206).

Then, the system control unit 124 reproduces and extracts the encoded data stored in the storage unit 122 and transmits the encoded data to the operations unit 132 through high speed transmission. In this way, the encoded data are stored in the memory 150 (step S210).

Then, the editing/processing control unit 154 determines whether a command to display a thumbnail image has been issued (step S212). For example, a general description such as index information of stored images may be displayed on the display panel 164 of the operations unit 132, and index information of a desired thumbnail image may be selected for display.

When a command to display a preview image has not been issued (step S220, NO), the process is ended.

On the other hand, when a command to display a thumbnail image has been issued (step S212, YES), the editing/processing control unit 154 decodes the encoded data stored in the memory 150 and generates decoded data (image data) (step S214). In this case, the editing/processing control unit 154 searches for the selected thumbnail image based on storage information of the encoded data that is managed by the system control unit 124 using file management software. Then, the editing/processing control unit 154 generates a thumbnail image from the decoded data (step S216). Then, the editing/processing control unit 154 displays the thumbnail image on the display panel 164 (step S218). The display panel 164 may display a general description of images such as page information of the images.

On the other hand, when a command to display a thumbnail image has not been issued (step S212, NO), the editing/processing control unit 154 determines whether a command to display a preview image has been issued (step S220).

When a command to display the preview image has been issued (step S220, YES), the editing/processing control unit 154 decodes the encoded data stored in the memory 150 to generate decoded data (step S222). Then, the editing/processing control unit 154 generates a preview image from the decoded data (step S224).

Then, the editing/processing control unit 154 determines whether a command to perform an editing process on the preview image has been issued (step S226).

When a command to perform an editing process on the preview image has not been issued (step S226, NO), the editing/processing control unit 154 performs a depiction process to display the preview image on the display panel 164 (step S228).

On the other hand, when a command to perform an editing process has been issued (step S226, YES), the editing/processing control unit 154 performs editing/processing operations on the preview image (step S230).

Then, the editing/processing control unit 154 performs a depiction process to display the edited/processed preview image on the display panel 164 (step S232).

Then, the editing/processing control unit 154 transmits the editing history information to the system control unit 124 (step S234).

The system control unit 124 receives the editing history information and performs editing/processing operations on the original image (actual image) decoded from relevant encoded data stored in the storage unit 122 according to the received editing history information to thereby reflect the editing/processing operations performed on the preview image in the original image (step S236). For example, the system control unit 124 may decode the relevant encoded data of the original image corresponding to the received editing history information at the decoding unit 120 to perform editing/processing operations on the decoded image according to the received editing history information. Then, the system control unit 124 may input the edited/processed decoded data to the write signal processing unit 112. In turn, the write signal processing unit 112 may input the decoded data to the plotter 104. In this way, the edited/processed image may be output from the plotter 104.

As can be appreciated from the above descriptions, in the imaging apparatus 100 according to the present embodiment, the controller 114 stores encoded data of an original image and performs editing/processing operations on the original image according to editing history information from the operations unit 132. The operations unit 132 stores encoded data reproduced from the encoded data of the original image, uses the reproduced encoded data to generate a thumbnail image and/or a preview image and perform editing/processing operations on the preview image, and transmits editing history information describing the editing/processing operations to the controller 114.

In this way, the processes of the controller 114 may be performed in parallel with the processes of the operations unit 132. For example, an image display process of the operations unit 132 may be performed in parallel with another functional process of the controller 114 such as a copying process.

Also, according to the present embodiment, the edited/processed preview image may be displayed on the display panel 164 before being output to the plotter 104 so that a user is given the opportunity to check the editing/processing result. In this way, errors may be detected before the edited/processed image is output to the plotter 104 so that faulty image outputs may be reduced. In other words, the likelihood of failing to obtain an image output anticipated or desired by the user may be reduced by implementing a function for previewing a pre-printing image. It is noted that the imaging apparatus of the present embodiment has a function for displaying a preview image of the original image corresponding to encoded data stored in the storage unit as well as a function for displaying the edited/processed preview image when editing/processing operations are performed on the preview image of the original image corresponding to the encoded data store in the storage unit.

It is noted that when a process for previewing an image is performed by the controller 114, the performance of other processes to be executed by the controller 114 may be degraded.

Accordingly, in the imaging apparatus 100 according to the present embodiment, the process for previewing an image is performed by the operations unit 132 while other functional processes are performed by the controller 114. In this way, degradation of the performance of the other functional processes may be avoided while an image display process is performed.

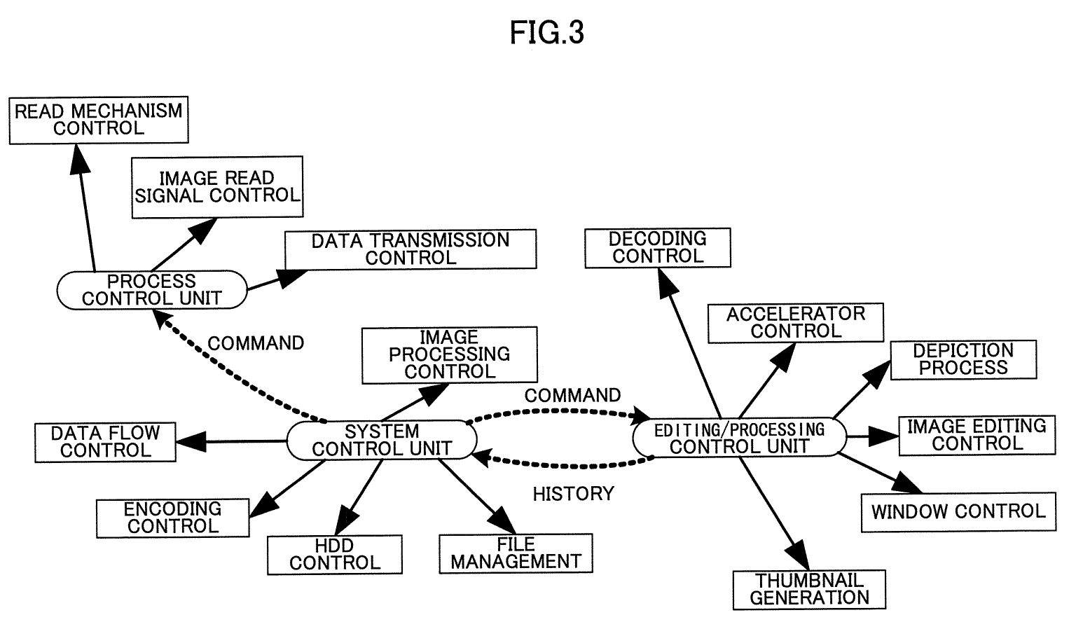

In the following, processes of the engine unit 106, the controller 114, and the operations unit 132 are described with reference to FIG. 3. It is noted that in the imaging apparatus 100 according to the present embodiment, the engine unit 106, the controller 114, and the operations unit 132 are operated by differing CPUs.

In the present embodiment, the process control unit 110 controls processes of the engine unit 106. The process control unit 110 may operate independently under management by the system control unit 124. For example, the process control unit 110 may control a read mechanism to read a document image. Also, the process control unit 110 may perform a correction process for correcting data degradation (image read signal control) via a read signal processing mechanism. Also, the process control unit 110 may control transmission of the read data to the controller 114.

The system control unit 124 controls processes of the controller 114. That is, the system control unit 124 performs overall control of the components of the controller 114. For example, the system control unit 124 may control data flow within the controller 114. The system control unit 124 may control image processing and the processing sequence thereof. The system control unit 124 may control an encoding process. The system control unit 124 may control the storage unit 122 such as a HDD and data access to the storage unit 122. The system control unit 124 may perform data file management of data stored in the storage unit 122.

The editing/processing control unit 154 controls processes of the operations unit 132. The editing/processing control unit 154 may operate independently under management by the system control unit 124. For example, the editing/processing control unit 154 may control a decoding process for decoding encoded data. The editing/processing control unit 154 may control the accelerator 156. The editing/processing control unit 154 may control window generation and the screen of the display panel 164. The editing/processing control unit 154 may perform a depiction process. The editing/processing control unit 154 may perform a thumbnail image generation process. The editing/processing control unit 154 may control image editing. The editing/processing control unit 154 may manage editing history information and feed back the editing history information to the system control unit 124.

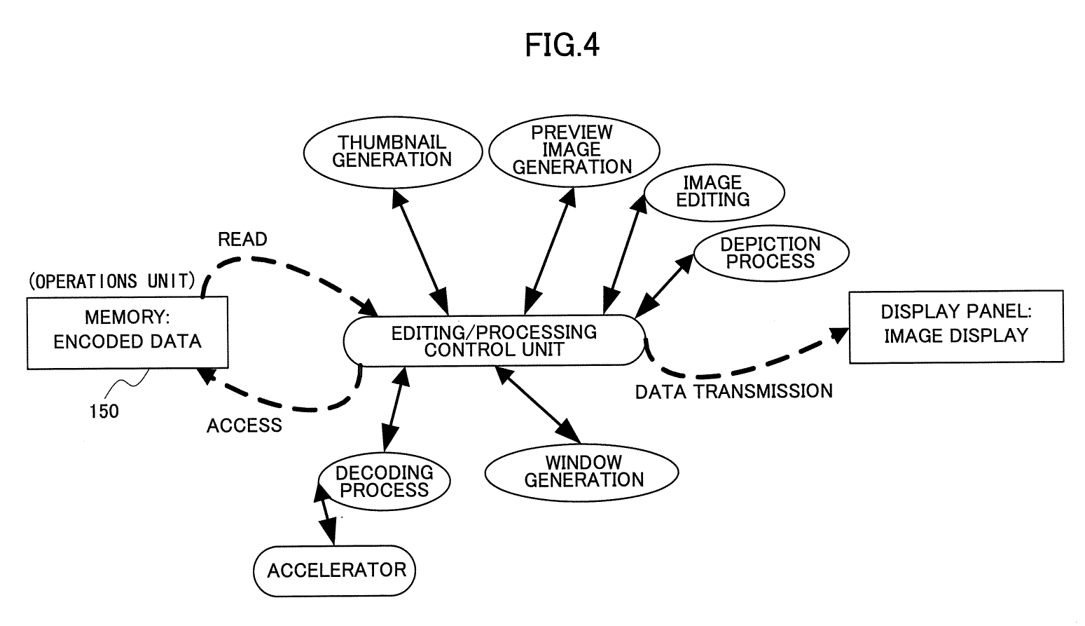

In the following, exemplary processes performed within the operations unit 132 by the editing/processing control unit 154 are described with reference to FIGS. 4-6.

In FIG. 4, the editing/processing control unit 154 accesses the memory 150 of the operations unit 132 and reads encoded data stored in the memory 150. Then, the editing/processing control unit 154 decodes the read encoded data. In one preferred embodiment, the editing/processing control unit 154 may use the accelerator 156 to perform the decoding process.

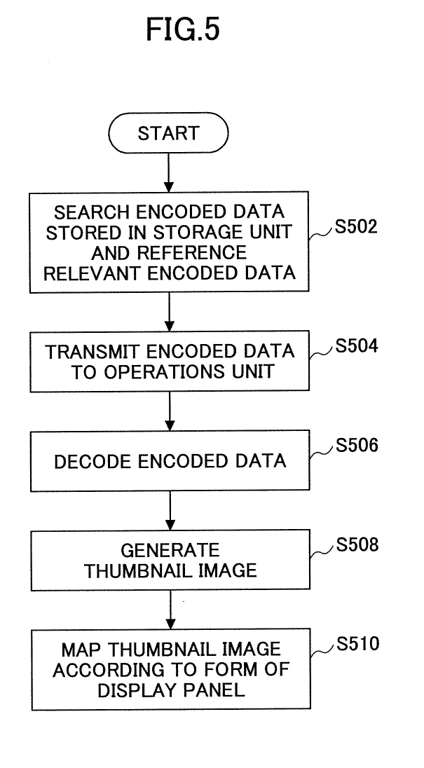

The editing/processing control unit 154 then generates a thumbnail image from the decoded data. FIG. 5 is a flowchart describing a thumbnail generation process according to an embodiment of the present invention.

In FIG. 5, the system control unit 124 performs a search on encoded data stored in the storage unit 122 to reference encoded data corresponding to a relevant image such as a document image read by the scanner 102 (step S502).

Then, the system control unit 124 transmits the encoded data corresponding to the relevant image to the operations unit 132 (step S504). In turn, the transmitted encoded data are stored in the memory 150.

Then, the editing/processing control unit 154 decodes the encoded data stored in the memory 150 (step S506).

Then, the editing/processing control unit 154 generates a thumbnail image from the decoded data (step S508).

Then, the editing/processing control unit 154 maps the thumbnail image according to the form of the display panel 164 (step S510). In this step, the editing/processing control unit 154 generates a window for displaying the thumbnail image.

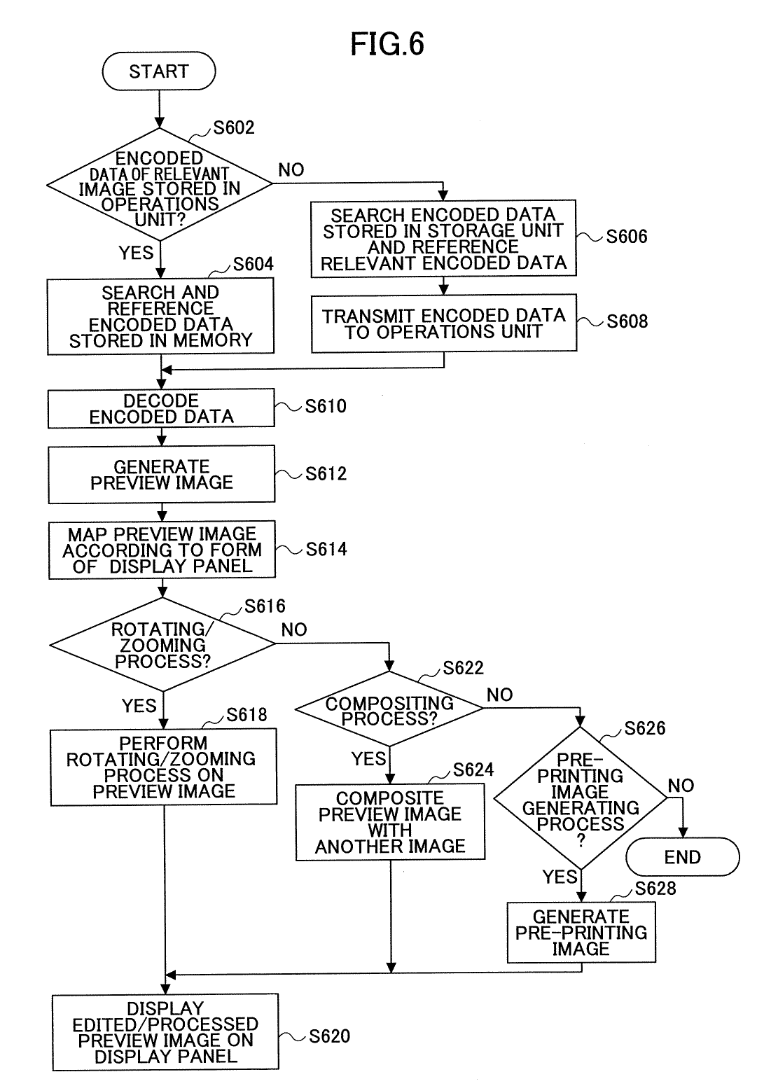

Also, the editing/processing control unit 154 generates a preview image. FIG. 6 is a flowchart describing a preview image generation process and an editing process according to an embodiment of the present invention.

In FIG. 6, the editing/processing control unit 154 determines whether encoded data of a relevant image are stored within the operations unit 132 (step S602). It is noted that since the capacity of the storage unit 122 is greater than that of the memory 150, the memory 150 may not be capable of storing all the encoded data accommodated in the storage unit 122. Thus, in some cases, when a thumbnail generating process is completed and new encoded data are transmitted from the controller 114 thereafter, the editing/processing control unit 154 may overwrite the transmitted encoded data in the area where the encoded data corresponding to the generated thumbnail image are written. In this case, although data of the thumbnail image remain, temporary information of the thumbnail image may not be available.

When encoded data corresponding to the relevant image are stored in the operations unit 132 (step S602, YES), the editing/processing control unit 154 searches and references the encoded data stored in the memory 150 (step S604). As can be appreciated, when encoded data of the relevant image are stored in the memory 150 of the operations unit 132, the encoded data stored in the memory 150 may be used. In this case, data exchange between the operations unit 132 and the controller 114 does not have to take place so that process steps of the operations unit 132 and the controller 114 are not interrupted by each other and efficient performance may be maintained.

On the other hand, when encoded data corresponding to the relevant image are not stored in the operations unit 132 (step S602, NO), the editing/processing control unit 154 sends a request for the corresponding encoded data to the system control unit 124.

In turn, the system control unit 124 searches the encoded data stored in the storage unit 122, references the corresponding encoded data (step S606), reproduces the corresponding encoded data, and transmits the reproduced encoded data to the operations unit 132 (step S608). In turn, the reproduced encoded data are written in the memory 150.

Then, the editing/processing control unit 154 decodes the encoded data written in the memory 150 (step S610) and generates a preview image (step S612).

Then, the editing/processing control unit 154 maps the preview image according to the form of the display panel 164 (step S614). In this step, the editing/processing control unit 154 generates a window for displaying the generated preview image.

Then, the editing/processing control unit 154 determines whether an editing process to be performed on the preview image displayed on the display panel 164 is a rotating/zooming process (step S616).

If the editing process to be performed on the displayed preview image is a rotating/zooming process (step S616, YES), the editing/processing control unit 154 uses the accelerator 156 to perform the rotating/zooming process (step S618). Then, the editing/processing control unit 154 performs a depiction process to display the rotated/zoomed preview image on the display panel 164 (step S620).

On the other hand, if the editing process to be performed on the displayed preview image is not a rotating/zooming process (step S616, NO), the editing/processing control unit 154 determines whether the editing process to be preformed on the displayed preview image is a compositing process (step S622).

If the editing process to be performed on the displayed preview image is a compositing process (step S622, YES), the editing/processing control unit 154 composites the preview image with another image (step S624). Then, the editing/processing control unit 154 performs a depiction process to display the composite preview image on the display panel 164 (step S620).

On the other hand, if the editing process to be performed on the displayed preview image is not a compositing process (step S622, NO), the editing/processing control unit 154 determines whether the editing process to be performed on the displayed preview image is a pre-printing preview image generating process (step S626).

If the editing process to be performed on the displayed preview image is a pre-printing preview image generating process (step S626, YES), the editing/processing control unit 154 uses the accelerator 156 to generate the pre-printing preview image. Then, the editing/processing control unit 154 performs a depiction process to display the pre-printing preview image on the display panel 164 (step S620).

On the other hand, if the editing process to be performed on the displayed preview image is not a pre-printing preview image generating process (step S626, NO), the process is ended.

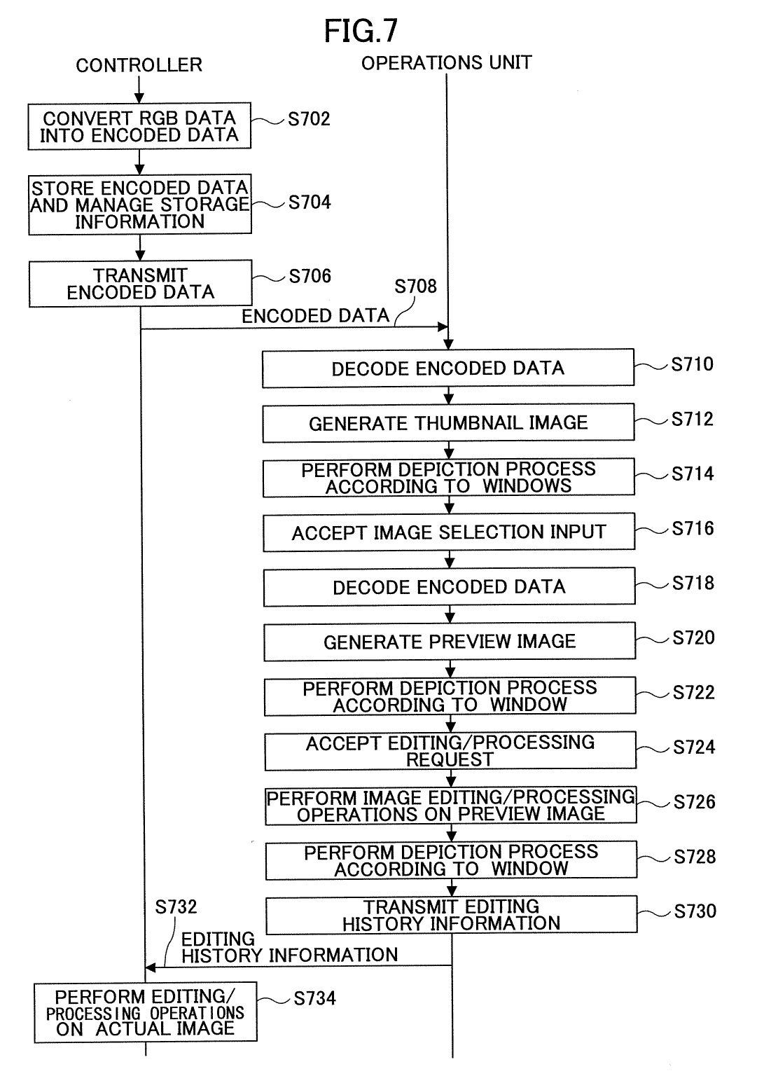

In the following, processes of the controller 114 and the operations unit 132 are described in detail with reference to FIG. 7.

In FIG. 7, RGB data are converted into encoded data by the encoding unit 118 (step S702) to be stored in the storage unit 122 (step S704). The system control unit 124 performs data file management of the encoded data stored in the storage unit 122 (step S704).

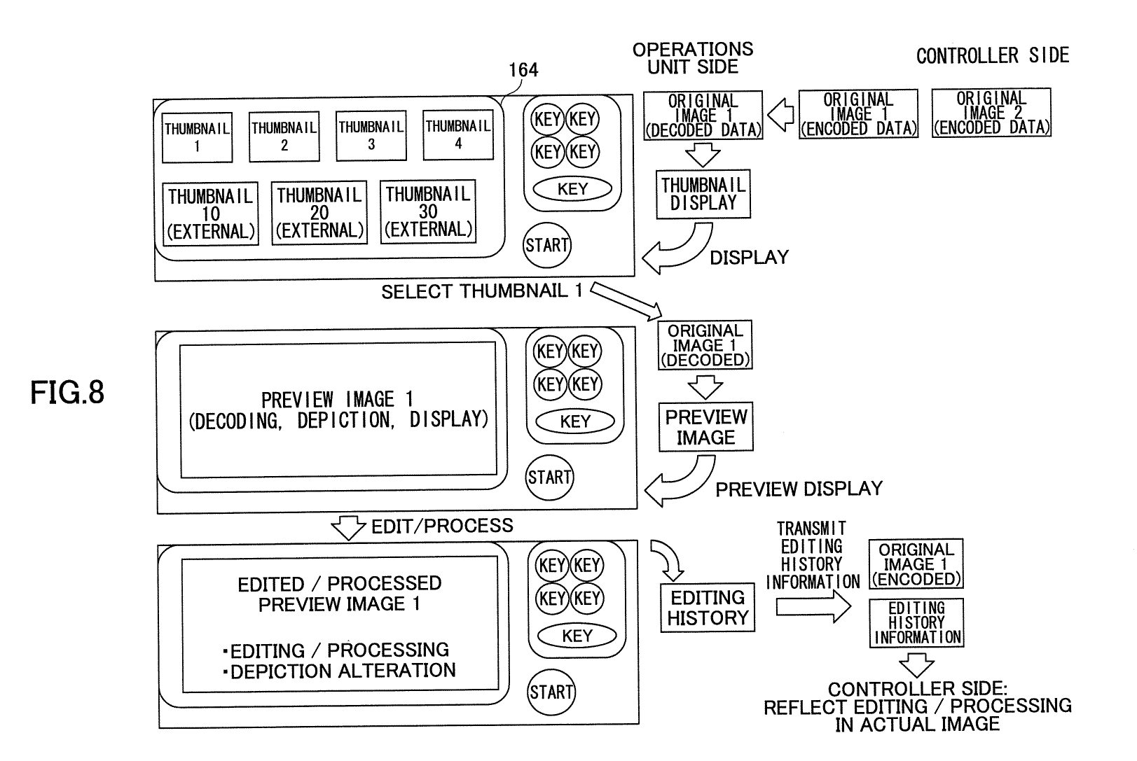

For example, as is shown in FIG. 8, encoded data of original image 1 and original image 2 may be stored in the storage unit 122.

Then, the system control unit 124 reproduces the stored encoded data and transmits the reproduced encoded data to the operations unit 132 (step S706). For example, the system control unit 124 may transmit the encoded data of original image 1 of FIG. 8 as the reproduced encoded data. In turn, the encoded data are transmitted from the controller 114 to the operations unit 132 (step S708), and the transmitted encoded data are stored in the memory 150.

Then, the editing/processing control unit 154 decodes relevant encoded data of the encoded data stored in the memory 150 (step S710). For example, the editing/processing control unit 154 may decode encoded data corresponding to original image 1.

Then, the editing/processing control unit 154 creates a thumbnail image from the decoded data (step S712).

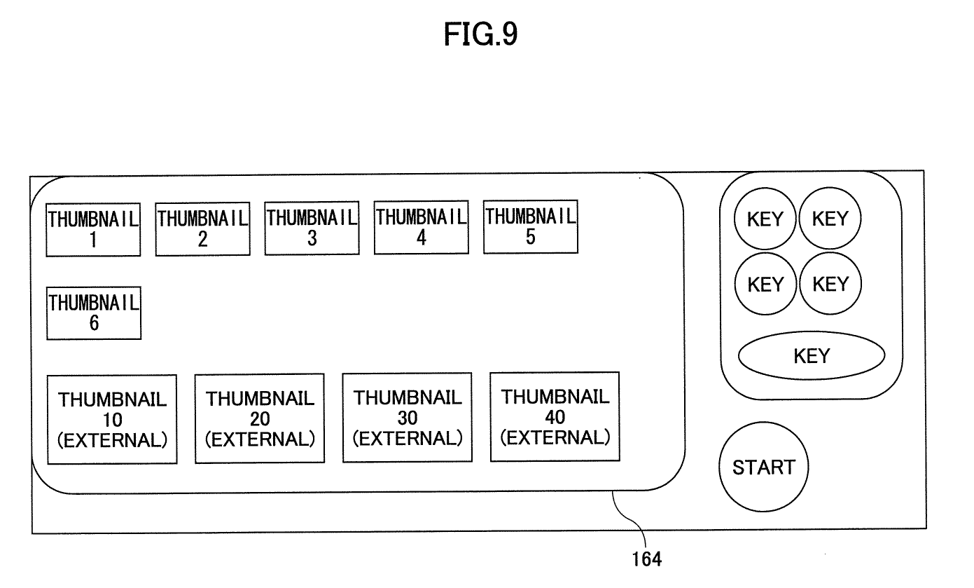

Then, the editing/processing control unit 154 performs a depiction process to display the thumbnail image according to windows configured by the display control unit 158 (step S714). For example, the display control unit 158 may configure plural windows for displaying plural thumbnail images. For example, as is shown in FIG. 9, windows for displaying thumbnail images corresponding to original images stored in the imaging apparatus 100 (i.e., thumbnail images 1-6) and windows for displaying thumbnail images corresponding to images stored in other external apparatuses (i.e., thumbnail images 10-40) may be configured by the display control unit 158.

For example, as is shown in FIG. 8, the editing/processing control unit 154 may display plural thumbnail images (i.e., thumbnail images 1-4) on the display panel 164. The editing/processing control unit 154 may also display thumbnail images corresponding to images stored in other external apparatuses. For example, the editing/processing control unit 154 may gather encoded data from other apparatuses such as a printer, another MFP, a server, and/or the Internet that are connected to the network 200 via the network control unit 130.

In another example, the editing/processing control unit 154 may gather encoded data from the SD card 138, the compact flash® 140, the memory stick 142, the DVD 144, and/or the external connection unit 146 of the extended operations unit 134 to generate thumbnail images based on the gathered encoded data.

Then, at least one image of the plural thumbnail images is selected (step S716). The selection may be performed through key input or touch panel input, for example. In the case where selection by key input is performed, the key input control unit 162 transmits information indicating the selected thumbnail image to the editing/processing control unit 154. In the case where selection through touch panel input is performed, the touch panel control unit 160 transmits information indicating the selected thumbnail image to the editing/processing control unit 154.

Then, the editing/processing control unit 154 decodes the encoded data corresponding to the selected thumbnail image (step S718), and generates a preview image corresponding to the selected thumbnail image (step S720).

Then, the editing/processing control unit 154 performs a depiction process to display the preview image according to a window configured by the display control unit 158 (step S722).

For example, in a case where thumbnail image 1 is selected, the editing/processing control unit 154 decodes encoded data of original image 1 corresponding to the thumbnail image 1 and generates a preview image from the decoded data. Then, the editing/processing control unit 154 performs a depiction process to display the generated preview image on the display panel 164. In this way, a preview image corresponding to thumbnail image 1 may be displayed as is shown in FIG. 8.

Then, the editing/processing control unit 154 receives an editing/processing request for editing/processing the displayed preview image (step S724).

Then, the editing/processing control unit 154 performs editing/processing operations on the displayed preview image according to the received editing/processing request (step S726).

Then, the editing/processing control unit 154 performs a depiction process to display the edited/processed preview image according to a window configured by the display control unit 158 (step S728). In this way, an edited/processed preview image that is altered from the preview image of the original image through processing/editing operations and/or depiction alterations may be displayed as is shown in FIG. 8.

The editing/processing control unit 154 generates editing history information describing editing and processing operations performed on the preview image of the original image and transmits the generated editing history information to the controller 114 (step S730). In this way, the editing history information is input to the system control unit 124 of the controller 114 (step S732).

Then, the system control unit 124 performs editing/processing operations on the corresponding original image stored in the storage unit 122 based on the editing history information to reflect the editing/processing operations performed on the preview image (step S734). In this way, an image reflecting the editing/processing operations performed at the operations unit 132 may be output.

In the present embodiment, after transmitting encoded data to the operations unit 132, the controller 114 may perform other operational processes such as printing image data input via the network 200 or inputting an image from the scanner 102 until it receives editing history information from the operations unit 132. In other words, the work load of the controller 114 may be reduced by implementing the present embodiment.

In the following, an imaging apparatus according to a second embodiment of the present invention is described.

It is noted that since the configuration of the imaging apparatus according to the second embodiment may be identical to that of the imaging apparatus 100 shown in FIG. 1, descriptions thereof are omitted.

In the imaging apparatus according to the second embodiment, the system control unit 124 and the editing/processing unit 154 have differing functions from those of the imaging apparatus 100 according to the first embodiment.

Specifically, according to the present embodiment, the scanner 102 reads a document image, generates RGB data, and inputs the generated RGB data to the read signal processing unit 108. The read signal processing unit 108 processes the input RGB signal and inputs the processed RGB data to the signal arbitration unit 116 via a high-speed bus. The signal arbitration unit 116 inputs the processed RGB data to the system control unit 124, which has a reproducing function, an actual image editing function, and a hierarchical image data generating function. The system control unit 124 converts the input RGB data into hierarchical data. In the present embodiment, the hierarchical data may comprise original image data, preview image data, and thumbnail image data. For example, the system control unit 124 may reproduce original image data to generate preview image data and thumbnail image data.

The system control unit 124 inputs the hierarchical data to the encoding unit 118 via the signal arbitration unit 116. The encoding unit 118 converts the hierarchical data, namely, the original image data, the preview image data, and the thumbnail image data into encoded data, associates these encoded data sets with each other, and inputs the encoded data to the storage unit 122. The storage unit 122 stores the encoded data, and the system control unit 124 manages storage information of the encoded data stored in the storage unit 122 using file management software stored in the memory 126.

The system control unit 124 transmits to the connection control unit 136 via the connection control unit 128 encoded data corresponding to a thumbnail image of the encoded data stored in the storage unit 122 according to a request from the operations unit 132. The connection control unit 136 transmits the input encoded data to the memory 150. The transmitted encoded data of the thumbnail image is thus stored in the memory 150. As can be appreciated, in the present embodiment, encoded data of a thumbnail image may be transmitted to the operations unit 132 when processing is to be performed at the operations unit 132. Since the amount of encoded data corresponding to a thumbnail image is less than the amount of data of an original image, data transmission efficiency may be improved.

The editing/processing unit 154 decodes encoded data corresponding to a thumbnail image that are recorded in the memory 150 and performs a depiction process to display the thumbnail image on the display panel 164. In one preferred embodiment, the editing/processing unit 154 may use the accelerator 156 to decode the encoded data.

When a thumbnail image is selected, the system control unit 124 transmits to the connection control unit 136 via the connection control unit 128 encoded data of the preview image associated with the selected thumbnail image out of the encoded data stored in the storage unit 122. The connection control unit 136 then transmits the input encoded data to the memory 150. As can be appreciated, in the present embodiment, encoded data of a preview image may be transmitted to the operations unit 132 when processing is to be performed at the operations unit 132. Since the amount of encoded data of a preview image is less than the amount of data of an original image, data transmission efficiency may be improved.

The editing/processing unit 154 decodes the encoded data of a preview image stored in the memory 150, calculates a preview position, and performs a depiction process to display the preview image on the display panel 164. In one preferred embodiment, the editing/processing unit 154 may use the accelerator 156 to decode the encoded data.

The editing/processing unit 154 also performs editing/processing operations on the preview image displayed on the display panel 164. For example, the editing/processing unit 154 may perform editing/processing operations such as stamping, compiling, and hole-punching according to instructions from a user. It is noted that the image data of the preview image are stored in the memory 150. The editing/processing unit 154 performs editing/processing operations on the image data stored in the memory 150 and displays the edited/processed preview image on the display panel 164. The editing/processing unit 154 manages editing history information describing the editing/processing operations performed on the preview image. The editing/processing unit 154 transmits the editing history information to the system control unit 124 so that the editing/processing operations performed on the preview image may be reflected in the actual image stored in the storage unit 122.

The system control unit 124 edits/processes the actual image according to the editing history information to reflect the editing/processing operations performed on the preview image. Then, the system control unit 124 may input the data of the edited/processed actual image to the write signal processing unit 112, for example. In this way, the edited/processed actual image may be output from the plotter 104, for example.

In another example, the system control unit 124 may input the data of the edited/processed actual image to the network control unit 130. In this way, the data of the edited/processed actual image may be output to the network 200 via the network control unit 130.

It is noted that the imaging apparatus according to the second embodiment may also comprise an embedded system as with the imaging apparatus according to the first embodiment. The embedded system may include a CPU that performs a calculation process according to a program, a ROM (read-only memory), a RAM (random access memory), an auxiliary storage device such as a flexible disk device, and a large-capacity external storage device such as a hard disk device, for example.

In one embodiment, programs for enabling a computer of the embedded system to function as the controller 114 and the operations unit 132 may be stored in a storage medium such as a flexible disk, a CD-ROM, or a memory card. When the storage medium is inserted into the auxiliary storage device of the computer, the programs stored in the medium may be read. In turn, the CPU may write the read programs on the RAM or the external storage device and perform the above-described processes of the imaging apparatus based on the programs. In another embodiment, the programs may be downloaded via the network 200.

It is noted that the program to be executed by the controller 114 may be stored in the memory 112, for example. Such a program may enable the computer to function as a storage unit for storing image data, an image data reproducing unit for reproducing the image data, and an actual image editing unit for performing editing processes on the image data stored in the storage unit according to editing processes performed on the reproduced image data, for example.

In one preferred embodiment, the program may also enable the computer to function as a hierarchical image data generating unit that generates preview image data and thumbnail image data from image data, and the storage unit may store the hierarchical data having the image data, the preview image data, and the thumbnail image data associated with each other.

In another preferred embodiment, when the computer functions as the actual image editing unit, the program may enable the computer to perform an editing process on the image data stored in the storage unit according to editing history information transmitted from the operations unit 132.

Also, it is noted that the program to be executed by the operations unit 132 may be stored in the storage 152, for example. Such a program may enable the computer to function as a reproduced image editing unit for performing an editing process on the reproduced image data and displaying the edited reproduced image data.

In one preferred embodiment, when the computer functions as the reproduced image editing unit, the program may enable the computer to acquire a thumbnail image from the storage unit.

In another preferred embodiment, when the computer functions as the reproduced image editing unit, the program may enable the computer to acquire a preview image corresponding to the thumbnail image from the storage unit and perform an editing process on the preview image.

In another preferred embodiment, when the computer functions as the reproduced image editing unit, the program may enable the computer to transmit editing history information describing the editing process performed on the preview image to the actual image editing unit.

In one embodiment, the controller 114 and the operations unit 132 may each store the programs for enabling execution of their corresponding functions so that the controller 114 and the operations unit 132 may be independently operated and power consumption may be reduced.

In another embodiment, the programs for enabling the functions of the controller 114 and the operations unit 132 may be stored in the controller 114.

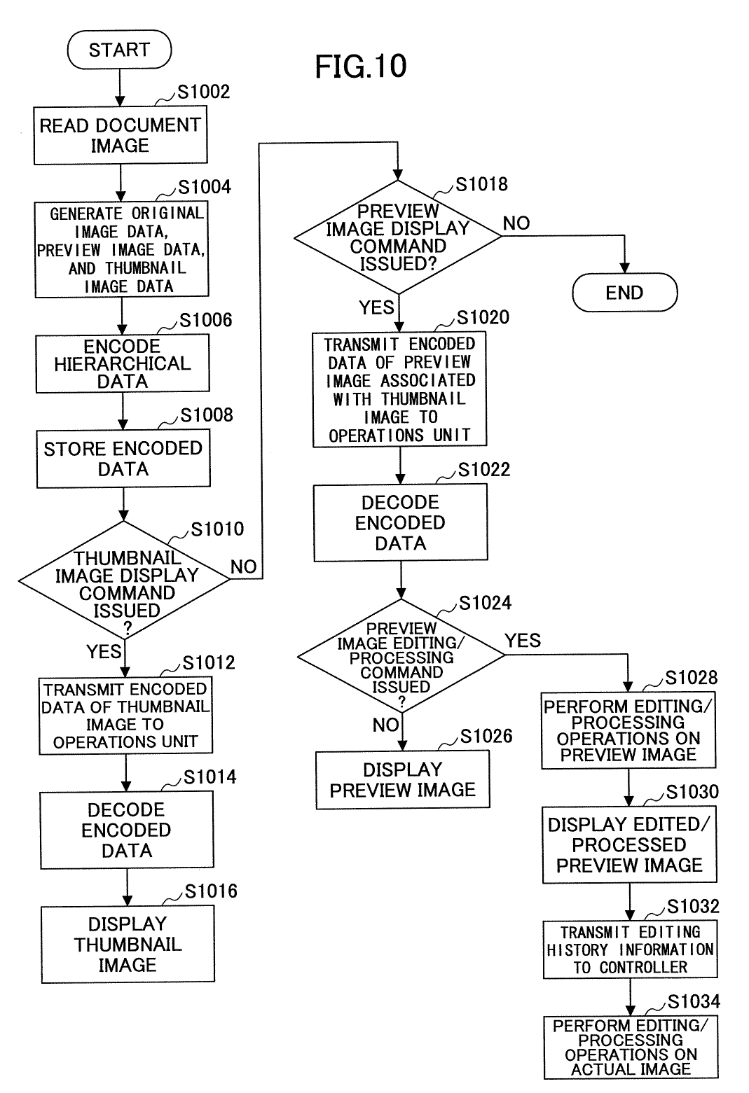

In the following, operations of the imaging apparatus according to the second embodiment are described with reference to FIG. 10.

According to FIG. 10, the scanner 102 reads a document image and generates RGB data (step S1002).

Then, the system control unit 124 generates storage images from the RGB data. For example, the system control unit 124 may generate an original image, a preview image, and a thumbnail image. In one specific example, the system control unit 124 may generate a 600 dpi image as the original image, a 100 dpi image as the preview image, and a 75 dpi image as the thumbnail image. Also, the system control unit 124 may generate hierarchical data from the RGB data that includes original image data, preview image data, and thumbnail image data (step S1004).

Then, the system control unit 124 inputs the hierarchical data to the encoding unit 118 to encode the hierarchical data (step S1006). The system control unit 124 associates the encoded data of the original image, the encoded tat of the preview image, and the encoded data of the thumbnail image with each other and stores the associated encoded data together with index information in the storage unit 122 (step S1008). For example, the encoding unit 118 may convert the hierarchical image data into JPEG data.

Then, the editing/processing unit 154 determines whether a command to display the thumbnail image has been issued (step S1010). For example, a general description of storage images such as index information may be displayed on the display panel 164 of the operations unit 132.

When a command to display a thumbnail image has been issued (step S1010, YES), the system control unit 124 extracts the encoded data of the thumbnail image stored in the storage unit 122 and transmits the encoded thumbnail image data to the operations unit 132 through high speed transmission (step S1012). In this way, the encoded data are stored in the memory 150. In one embodiment, the system control unit 124 may extract the encoded data of the relevant thumbnail image by searching the storage information of the encoded data that is managed by file management software.

Then, the editing/processing control unit 154 decodes the encoded data stored in the memory 150 to generate decoded data (step S1014). Then, the editing/processing control unit 154 displays the thumbnail image on the display panel 164 (step S1016). The display panel 164 may display a general description of images such as page information of the images.

On the other hand, when a command to display a thumbnail image has not been issued (step S1010, NO), the editing/processing control unit 154 determines whether a command to display a preview image has been issued (step S1018).

When a command to display a preview image has not been issued (step S1018, NO), the process is ended.

On the other hand, when a command to display a preview image is issued (step S1018, YES), the system control unit 124 extracts encoded data of the preview image associated with the thumbnail image stored in the storage unit 122, and transmits the encoded preview image data to the operations unit 132 through high speed transmission (step S1020). In this way, the encoded data of the preview image are stored in the memory 150.

The editing/processing control unit 154 decodes the encoded data stored in the memory 150 to generate decoded data (step S1022). Then, the editing/processing control unit 154 determines whether a command to perform an editing process on the preview image has been issued (step S1024).

When a command to perform an editing process on the preview image has not been issued (step S1024, NO), the editing/processing control unit 154 performs a depiction process to display the preview image on the display panel 164 (step S1026).

On the other hand, when a command to perform an editing process has been issued (step S1024, YES), the editing/processing control unit 154 performs editing/processing operations on the preview image (step S1028).

Then, the editing/processing control unit 154 performs a depiction process to display the edited/processed preview image on the display panel 164 (step S1030).

Then, the editing/processing control unit 154 transmits the editing history information to the system control unit 124 (step S1032).

In turn, the system control unit 124 receives the editing history information and performs editing/processing operations on the relevant original image according to the received editing history information to reflect the editing/processing operations performed on the preview image (step S1034). For example, the system control unit 124 may decode encoded data of the original image corresponding to the received editing history information at the decoding unit 120 and perform editing/processing operations on the decoded image according to the received editing history information. Then, the system control unit 124 may input the edited/processed decoded data to the write signal processing unit 112. In turn, the write signal processing unit 112 may input the decoded data to the plotter 104. In this way, the edited/processed image may be output from the plotter 104.

As can be appreciated from the above descriptions, in the imaging apparatus according to the present embodiment, the controller 114 stores an original image, a thumbnail image, and a preview image in the form of encoded data and performs editing/processing operations on the original image according to editing history information from the operations unit 132. The operations unit 132 decodes the thumbnail image and the preview image, performs editing/processing operations on the preview image, and transmits editing history information to the controller 114.

In this way, a process of the controller 114 may be performed in parallel with a process of the operations unit 132. For example, an image display process of the operation unit 132 may be performed in parallel with some other functional process of the controller 114 such as a copying process.

Also, according to the present embodiment, the edited/processed preview image is displayed on the display panel 164 before being output to the plotter 104 so that a user is given the opportunity to check the editing/processing result. In this way, errors may be detected before the edited/processed image is output to the plotter 104 so that faulty image outputs may be reduced. In other words, the likelihood of failing to obtain an image output anticipated or desired by the user may be reduced by implementing a pre-printing preview function for previewing the image to be printed. It is noted that the imaging apparatus of the present embodiment has a function for displaying a preview image of an image corresponding to encoded data stored in the storage unit as well as a function for displaying the edited/processed preview image when editing/processing operations are performed on the preview image of the image corresponding to the encoded data.

It is noted when a process for previewing an image is performed by the controller 114, the performance of other operational processes of the controller 114 may be degraded.

Accordingly, in the imaging apparatus according to the present embodiment, the process for previewing an image is performed by the operations unit 132 while other functional processes are performed by the controller 114. In this way, degradation of the performance of the other functional processes may be avoided while an image display process is performed.

Also, it is noted that in the imaging apparatus according to the present embodiment, hierarchical data are generated at the controller side so that the processing work load of the operations unit 132 may be reduced compared to the first embodiment. In turn, the operations unit 132 may be configured to perform other processes such as an animation display process and/or a web browser display process, for example.

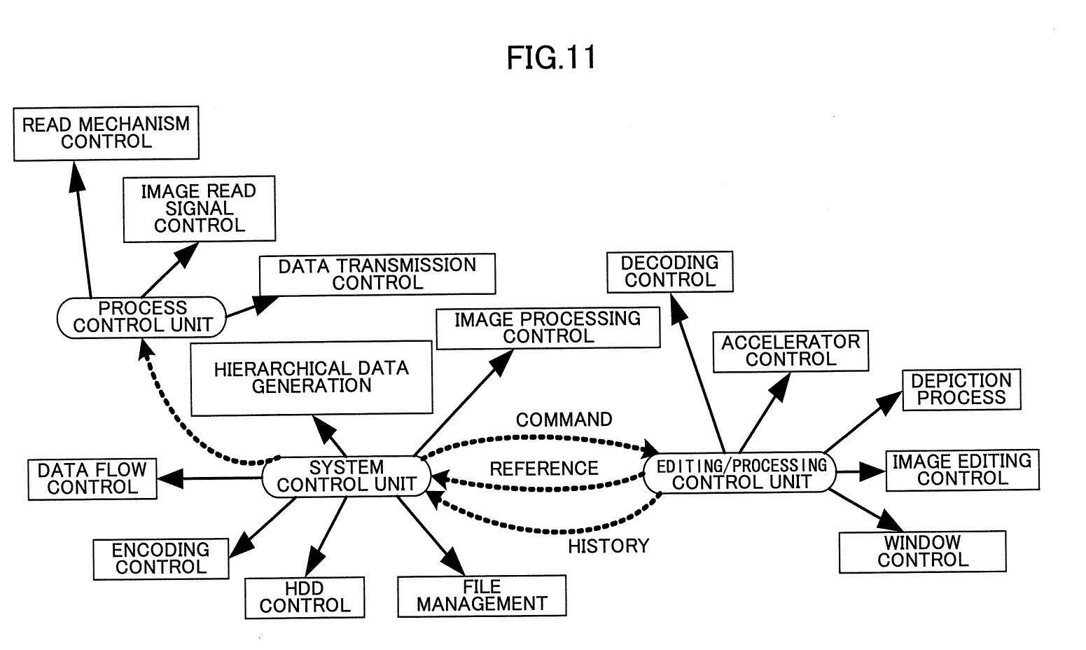

In the following, processes of the engine unit 106, the controller 114, and the operations unit 132 are described with reference to FIG. 11. It is noted that in the imaging apparatus according to the present embodiment, the engine unit 106, the controller 114, and the operations unit 132 are operated by differing CPUs.

In the present embodiment, the process control unit 110 controls processes of the engine unit 106. The process control unit 110 may operate independently under management by the system control unit 124. For example, the process control unit 110 may control a read mechanism to read a document image. Also, the process control unit 110 may perform a correction process for correcting data degradation (image read signal control) via a read signal processing mechanism. Also, the process control unit 110 may control transmission of the read data to the controller 114.

The system control unit 124 controls processes of the controller 114. That is, the system control unit 124 performs overall control of the components of the controller 114. For example, the system control unit 124 may control data flow within the controller 114. The system control unit 124 may control image processing and the processing sequence thereof. The system control unit 124 may control a process of generating hierarchical data including data of a preview image and a thumbnail image, for example. The system control unit 124 may control an encoding process. The system control unit 124 may control the storage unit 122 such as a HDD and data access to the storage unit 122. The system control unit 124 may perform data file management of data stored in the storage unit 122.

The editing/processing control unit 154 controls processes of the operations unit 132. The editing/processing control unit 154 may operate independently under management by the system control unit 124. For example, the editing/processing control unit 154 may control a decoding process for decoding encoded data. The editing/processing control unit 154 may control the accelerator 156. The editing/processing control unit 154 may control window generation and the screen of the display panel 164. The editing/processing control unit 154 may perform a depiction process. The editing/processing control unit 154 may control image editing. The editing/processing control unit 154 may manage editing history information and feed back the editing history information to the system control unit 124.

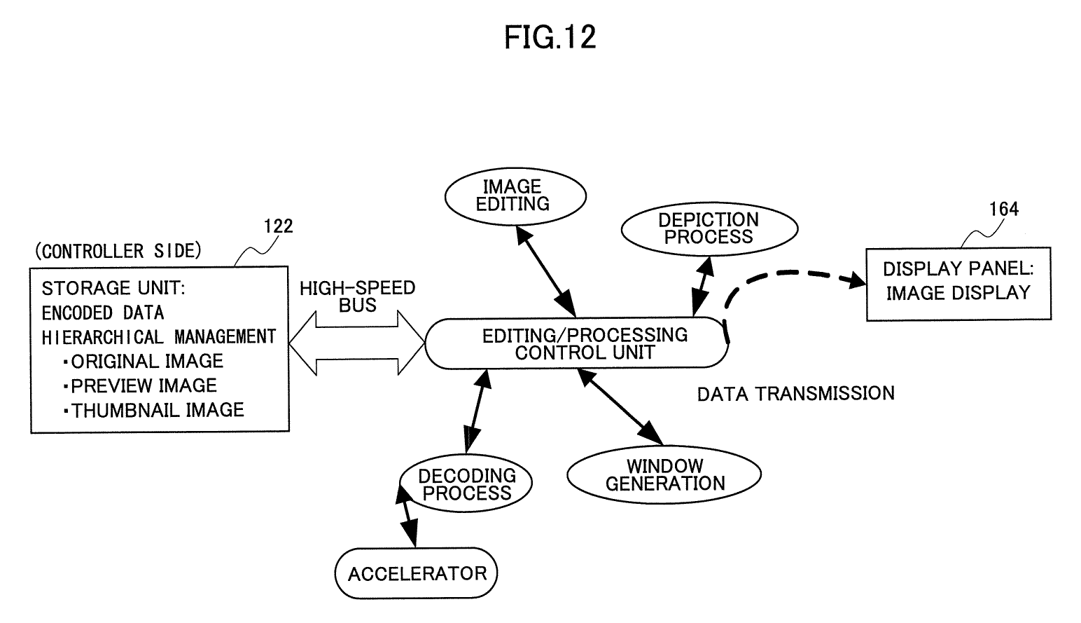

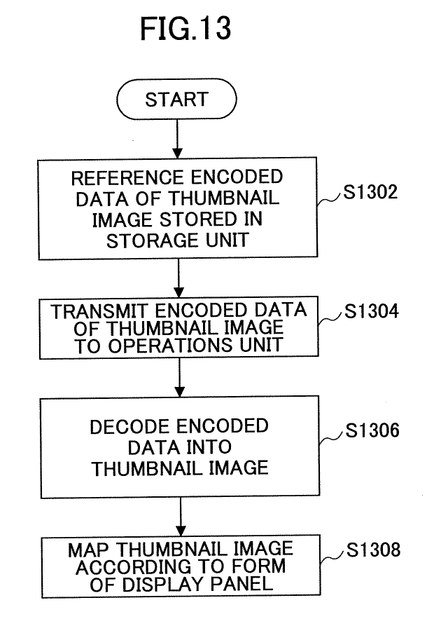

In the following, exemplary processes performed within the operations unit 132 by the editing/processing control unit 154 are described with reference to FIGS. 12 and 13.

FIG. 13 is a flowchart illustrating a process of displaying a thumbnail image.

In FIG. 13, the editing/processing control unit 154 accesses the controller 114 via a high-speed bus and instructs the system control unit 124 to reference the encoded data of thumbnail images stored in the storage unit 122 (step S1302).

In turn, the system control unit 124 reads the encoded data of a thumbnail image stored in the storage unit 122 according to the instructions from the editing/processing control unit 154 and transmits the encoded data to the operations unit 132 (step S1304). In this way, the encoded data of the thumbnail image are stored in the memory 150.

Then, the editing/processing control unit 154 decodes the encoded data stored in the memory 150 (step S1306). In this way, the thumbnail image data may be decoded. In one preferred embodiment, the editing/processing control unit 154 may use the accelerator 156 to perform the decoding process.

Then, the editing/processing control unit 154 maps the thumbnail image according to a form used by the display panel 164 (step S1308). In this step, the editing/processing control unit 154 may perform a window generating process, a depiction process, and transmission control of data transmitted to the display panel 164, for example.

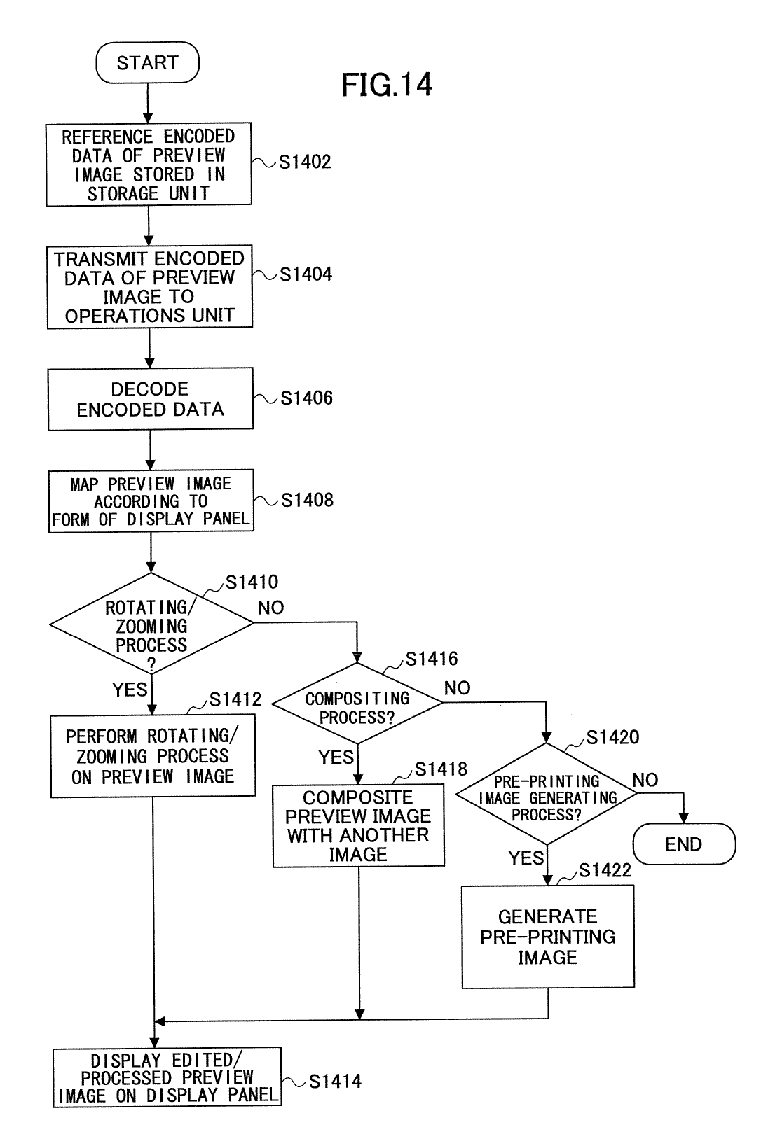

FIG. 14 is a flowchart illustrating a process of displaying a preview image.

In FIG. 14, the editing/processing control unit 154 accesses the controller 114 via a high-speed bus and directs the system control unit 124 to reference the encoded data of preview images stored in the storage unit 122 (step S1402).

Then, the system control unit 124 reads encoded data of a preview image stored in the storage unit 122 according to the instructions from the editing/processing control unit 154 and transmits the encoded data to the operations unit 132 (step S1404). In turn, the encoded data of the preview image are stored in the memory 150.

The editing/processing control unit 154 decodes the encoded data stored in the memory 150 (step S1406). In this way the preview image data may be decoded. In one embodiment, the editing/processing control unit 154 may use the accelerator 156 to perform the decoding process.

Then, the editing/processing control unit 154 maps the preview image according to the form used by the display panel 164 (step S1408). In this step, the editing/processing control unit 154 may perform a window generating process, a depiction process, and transmission control of data transmitted to the display panel 164, for example.

Then, the editing/processing control unit 154 determines whether an editing process to be performed on the preview image displayed on the display panel 164 is a rotating/zooming process (step S1410).

If the editing process to be performed on the displayed preview image is a rotating/zooming process (step S1410, YES), the editing/processing control unit 154 uses the accelerator 156 to perform the rotating/zooming process (step S1412). Then, the editing/processing control unit 154 performs a depiction process to display the rotated/zoomed preview image on the display panel 164 (step S1414).

On the other hand, if the editing process to be performed on the displayed preview image is not a rotating/zooming process (step S1410, NO), the editing/processing control unit 154 determines whether the editing process to be preformed on the displayed preview image is a compositing process (step S1416).

If the editing process to be performed on the displayed preview image is a compositing process (step S1416, YES), the editing/processing control unit 154 composites the preview image with another image (step S1418). Then, the editing/processing control unit 154 performs a depiction process to display the composite preview image on the display panel 164 (step S1414).

On the other hand, if the editing process to be performed on the displayed preview image is not a compositing process (step S1416, NO), the editing/processing control unit 154 determines whether the editing process to be performed on the displayed preview image is a pre-printing preview image generating process (step S1420).

If the editing process to be performed on the displayed preview image is a pre-printing preview image generating process (step S1420, YES), the editing/processing control unit 154 uses the accelerator 156 to generate the pre-printing preview image (step S1422). Then, the editing/processing control unit 154 performs a depiction process to display the pre-printing preview image on the display panel 164 (step S1414).

On the other hand, if the editing process to be performed on the displayed preview image is not a pre-printing preview image generating process (step S1420, NO), the process is ended.

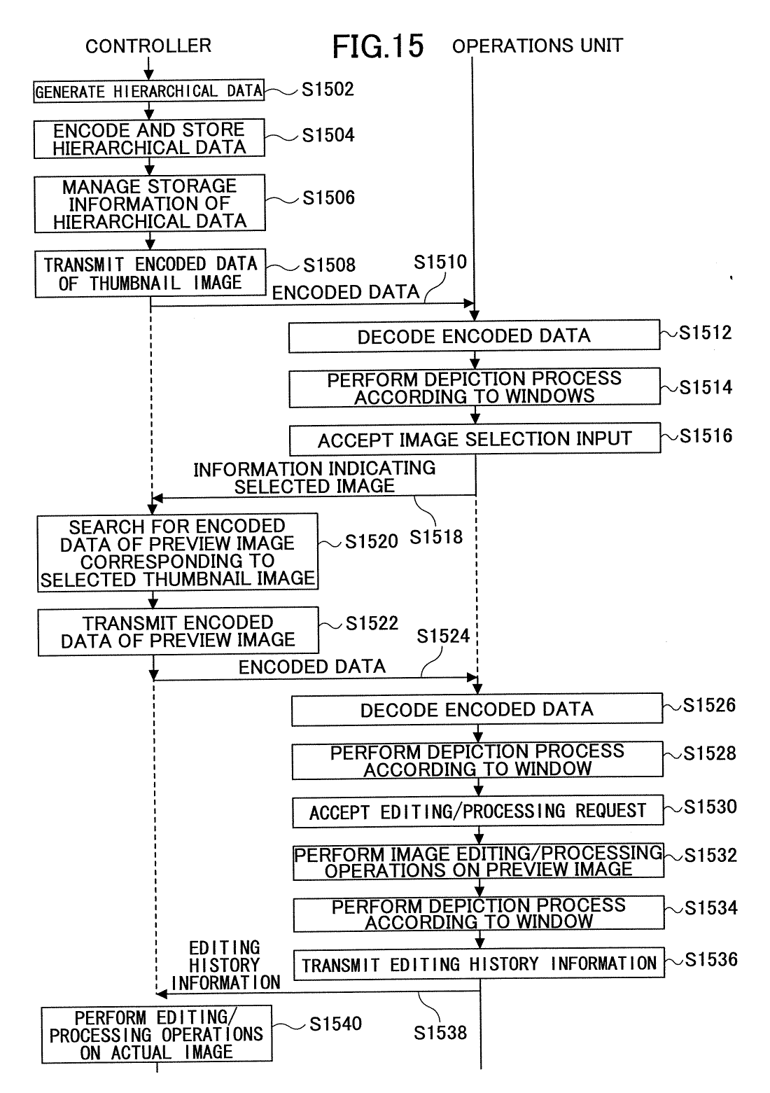

In the following, processes of the controller 114 and the operations unit 132 are described in detail with reference to FIG. 15.

In FIG. 15, the system control unit 124 generates hierarchical data such as original image data, preview image data, and thumbnail image data from RGB data (step S1502). For example, the system control unit 124 reproduces the original image data to create the preview image data and the thumbnail image data. The hierarchical data are encoded by the encoding unit 118 (step S1504), associated with each other, and stored in the storage unit 122 (step S1504). The system control unit 124 performs data file management of the encoded data stored in the storage unit 122 (step S1506).

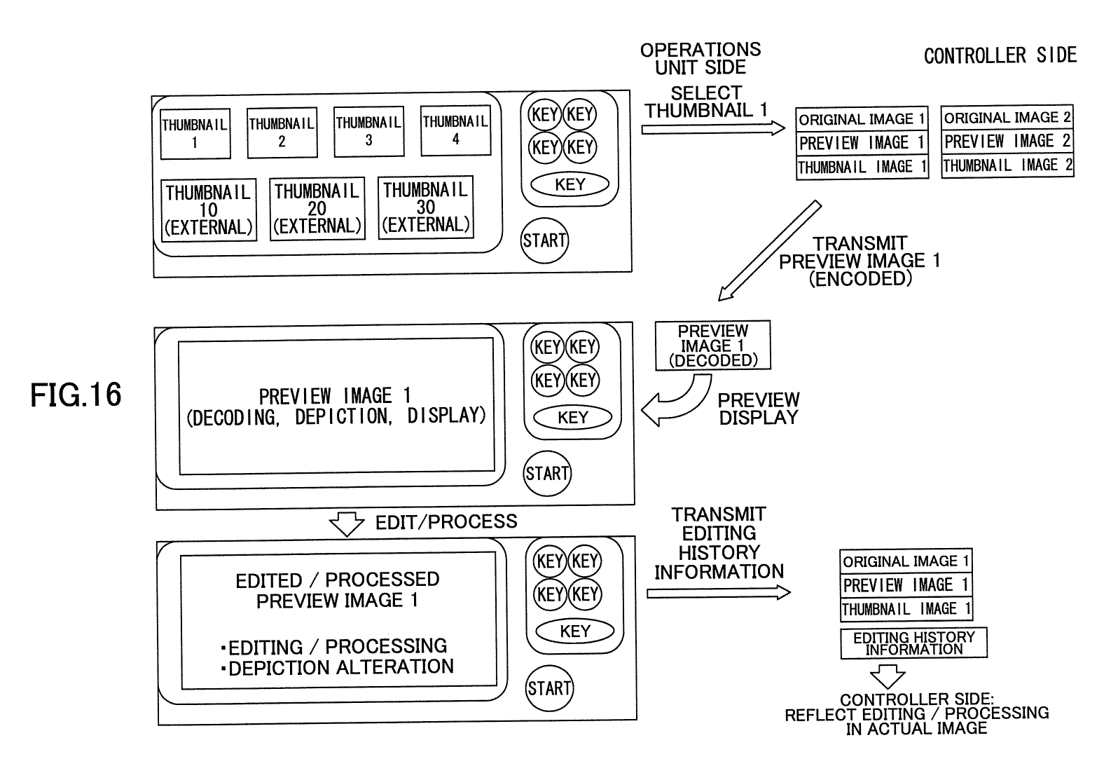

For example, as is shown in FIG. 16, original image 1, preview image 1, and thumbnail image 1 may be associated with each other to be stored in the storage unit 122; and original image 2, preview image 2, and thumbnail image 2 may be associated with each other to be stored in the storage unit 122.

Then, the system control unit 124 transmits the encoded data of a thumbnail image to the operations unit 132 (step S1508). For example, the system control unit 124 may transmit encoded data thumbnail image 1 and encoded data of thumbnail image 2 to the operations unit 132. In this way, the encoded data of the thumbnail images may be transmitted via a high-speed bus to be stored in the memory 150 (step S1510).

Then, the editing/processing control unit 154 decodes the encoded data stored in the memory 150 (step S1512).

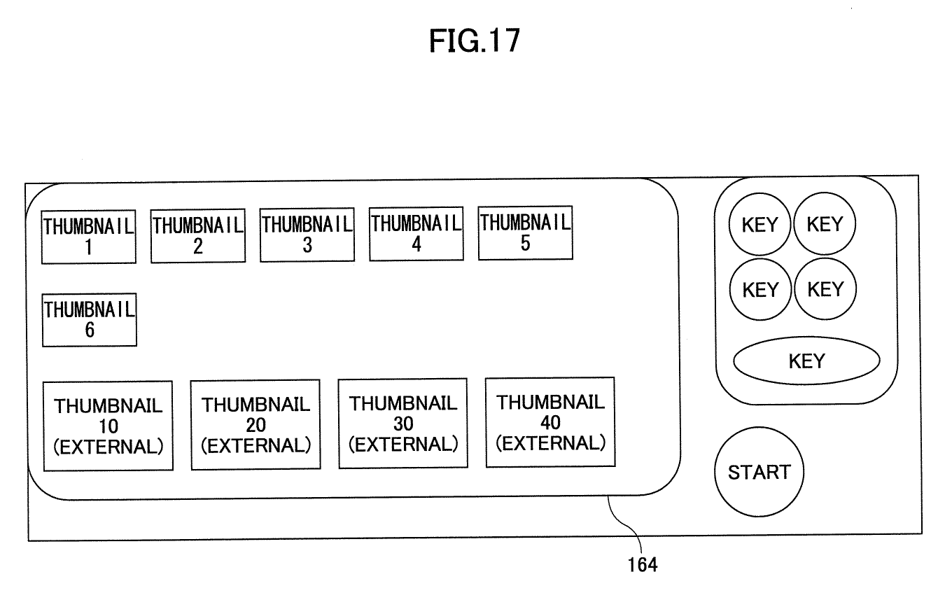

Then, the editing/processing control unit 154 performs a depiction process to display the thumbnail images according to windows configured by the display control unit 158 (step S1514). For example, the display control unit 158 may configure plural windows for displaying plural thumbnail images. For example, as is shown in FIG. 17, windows for displaying thumbnail images corresponding to original images stored in the present imaging apparatus (i.e., thumbnail images 1-6) and windows for displaying thumbnail images corresponding to images stored in other external apparatuses (i.e., thumbnail images 10-40) may be configured by the display control unit 158.

For example, as is shown in FIG. 16, the editing/processing control unit 154 may display plural thumbnail images (e.g., thumbnail images 1-4) on the display panel 164. The editing/processing control unit 154 may also display thumbnail images corresponding to images stored in other external apparatuses. For example, the editing/processing control unit 154 may gather encoded data from other apparatuses such as a printer, another MFP, a server, and/or the Internet that are connected to the network 200 via the network control unit 130 and generate thumbnail images based on the gathered encoded data.

In another example, the editing/processing control unit 154 may gather encoded data from the SD card 138, the compact flash® 140, the memory stick 142, the DVD 144, and/or the external connection unit 146 of the extended operations unit 134 to generate thumbnail images based on the gathered encoded data.

Then, at least one image of the plural thumbnail images is selected (step S1516). The selection may be performed through key input or touch panel input, for example. In the case where selection by key input is performed, the key input control unit 162 transmits information indicating the selected thumbnail image to the editing/processing control unit 154. In the case where selection through touch panel input is performed, the touch panel control unit 160 transmits information indicating the selected thumbnail image to the editing/processing control unit 154.

Then, the editing/processing control unit 154 transmits information indicating the selected thumbnail image to the system control unit 124 via a high-speed bus, for example (step S1518).

Then, the system control unit 124 searches for the encoded data of the preview image corresponding to the selected thumbnail image (step S1520). For example, as is shown in FIG. 16, if thumbnail image 1 is selected, the system control unit 124 references the storage unit 122 to search for the encoded data of preview image 1 stored in association with thumbnail image 1.

Then, the system control unit 124 transmits the encoded data of the relevant preview image to the operations unit 132 (step S1522). In turn, the encoded data of the relevant preview image are transmitted to the operations unit 132 via a high-speed bus to be stored in the memory 150 (step S1524).

Then, the editing/processing control unit 154 decodes the encoded data of the relevant preview image stored in the memory 150 (step S1526).

Then, the editing/processing control unit 154 performs a depiction process to display the preview image according to a window configured by the display control unit 158 (step S1528). For example, as is shown in FIG. 16, preview image 1 corresponding to thumbnail image 1 may be displayed on the display panel 164.

Then, the editing/processing control unit 154 receives an editing/processing request for editing/processing the displayed preview image (step S1530).

Then, the editing/processing control unit 154 performs editing/processing operations on the displayed preview image according to the received editing/processing request (step S1532).

Then, the editing/processing control unit 154 performs a depiction process to display the edited/processed preview image according to a window configured by the display control unit 158 (step S1534). In this way, an edited/processed preview image that is altered from the preview image displayed in step S1530 through at least one of processing/editing and depiction alteration may be displayed as is shown in FIG. 16.

Then, the editing/processing control unit 154 generates editing history information describing the editing/processing operations performed on the preview image and transmits the generated editing history information to the controller 114 (step S1536). In this way, the editing history information is input to the system control unit 124 of the controller 114 via a high-speed bus (step S1538).

Then, the system control unit 124 performs editing/processing operations on the corresponding original image stored in the storage unit 122 based on the editing history information to reflect the editing/processing performed on the preview image (step S1540). In this way, an image reflecting the editing/processing performed at the operations unit 132 may be output.

In the present embodiment, the controller 114 may perform other operation processes such as printing image data input via the network 200 or inputting an image via the scanner 102 after it transmits encoded data of a thumbnail image to the operations unit 132 until it receives information indicating a selected image or after it transmits encoded data of a preview image to the operations unit 132 until it receives editing history information from the operations unit 132. Also, since encoded data of the thumbnail image and encoded data of a preview image are generated at the controller 114 side and transmitted to the operations unit 132 as is necessary or desired, data transmission to the operations unit 132 may be efficiently performed in a shorter period of time compared to the first embodiment. Also, the work load of the operations unit 132 may be reduced compared to the first embodiment.

It is noted that embodiments of the present invention may be applied to a printer, a scanner, a facsimile machine, or a multi-function machine having a combination of the functions of the above apparatuses, for example.

Although the present invention is shown and described with respect to certain preferred embodiments, it is obvious that equivalents and modifications may occur to others skilled in the art upon reading and understanding the specification. The present invention includes all such equivalents and modifications, and is limited only by the scope of the claims.

The present application is based on and claims the benefit of the earlier filing date of Japanese Patent Application No. 2005-364919 filed on Dec. 19, 2005, the entire contents of which are hereby incorporated by reference.

What is claimed is:

1. An imaging apparatus comprising:
a storage unit that stores image data;
an image data reproducing unit that reproduces the image data;
a reproduced image editing unit that performs a first editing process on the reproduced image data and displays an edited image resulting from the first editing process; and
an actual image editing unit that performs a second editing process on the image data stored in the storage unit according to the first editing process.

2. The imaging apparatus as claimed in claim 1, wherein
the reproduced image editing unit generates a thumbnail image from the reproduced image data.

3. The imaging apparatus as claimed in claim 2, wherein
the reproduced image editing unit generates a preview image corresponding to the thumbnail image and performs the first editing process on the preview image.

4. The imaging apparatus as claimed in claim 1, wherein
the reproduced image editing unit transmits editing history information describing the first editing process to the actual image editing unit; and
the actual image editing unit performs the second editing process on the image data stored in the storage unit according to the editing history information.

5. The imaging apparatus as claimed in claim 1, further comprising:
a hierarchical data generating unit that generates preview image data and thumbnail image data from the image data;
wherein the storage unit associates the image data, the preview image data, and the thumbnail image data with each other and stores the associated image data, preview image data, and thumbnail image data.

6. The imaging apparatus as claimed in claim 5, wherein
the reproduced image editing unit acquires the thumbnail image data from the storage unit.

7. The imaging apparatus as claimed in claim 6, wherein
the reproduced image editing unit acquires the preview image data associated with the acquired thumbnail image data from the storage unit and performs the first editing process on the acquired preview image data.

8. The imaging apparatus as claimed in claim 5, wherein
the reproduced image editing unit transmits editing history information describing the first editing process to the actual image editing unit; and
the actual image editing unit performs the second editing process on the image data stored in the storage unit according to the editing history information.

9. An image forming method comprising the steps of:
storing image data;
reproducing the image data;
performing a first editing process on the reproduced image data;
displaying a processed image resulting from the first editing process; and
performing a second image editing process on the image data stored in the storage unit according to the first editing process.

10. A computer-readable program for forming an image which program, when executed by a computers causes the computer to perform the steps of:
storing image data;
reproducing the image data;
performing a first editing process on the reproduced image data;
displaying a processed image resulting from the first editing process; and
performing a second image editing process on the image data stored in the storage unit according to the first editing process.

11. A computer-readable medium containing a computer-readable program for forming an image, the program being executed by a computer to perform the steps of:
storing image data;
reproducing the image data;
performing a first editing process on the reproduced image data;
displaying a processed image resulting from the first editing process; and
performing a second image editing process on the image data stored in the storage unit according to the first editing process.
